(19) United States
(12) Patent Application Publication
(10) Pub. No.: US 2025/0153279 A1
(43) Pub. Date: May 15, 2025

(54) NUGGET DIAMETER ESTIMATION METHOD

(71) Applicant: TOYOTA JIDOSHA KABUSHIKI KAISHA, Toyota-shi, Aichi-ken (JP)

(72) Inventors: Shuhei OGURA, Nagakute-shi (JP); Tomohiko SEKIGUCHI, Nagakute-shi (JP); Kyosuke IZUNO, Nisshin-shi (JP); Yuki MATSUGI, Nisshin-shi (JP); Yasuaki OKITA, Chiba-shi (JP); Mizuki KODAMA, Yukuhashi-shi (JP)

(73) Assignee: TOYOTA JIDOSHA KABUSHIKI KAISHA, Toyota-shi, Aichi-ken (JP)

(21) Appl. No.: 18/859,051

(22) PCT Filed: Apr. 26, 2023
(86) PCT No.: PCT/JP2023/016473

§ 371 Date: Oct. 22, 2024

(30) Foreign Application Priority Data
May 24, 2022 (JP) 2022-084205

(51) Int. Cl. B23K 31/12; B23K 11/11; B23K 11/25

(52) U.S. Cl. CPC B23K 31/125; B23K 11/115; B23K 11/253; B23K 11/255; B23K 11/257

(57) ABSTRACT

A nugget diameter estimation method of a welded material bonded by resistance spot welding includes: a reference welding process of bonding a test material while measuring an expansion amount of the test material; a nugget diameter measurement process of measuring a nugget diameter of the bonded test material; a relational formula determination process of determining a relational formula between the measured nugget diameter of the test material and the expansion amount of the test material; a main welding process of measuring an expansion amount of the welded material, and bonding the welded material through energization while pressurizing the welded material with the pair of electrodes; and a nugget diameter estimation process of estimating a nugget diameter of the bonded welded material using the expansion amount of the welded material and the relational formula.

### CROSS REFERENCE TO RELATED APPLICATION

This application is based upon prior Japanese Patent Application No. 2022-084205 filed on May 24, 2022, the entire contents of which are incorporated herein by reference.

### TECHNICAL FIELD

The present disclosure relates to a nugget diameter estimation method.

### BACKGROUND ART

A welding device has been known configured to store, as reference data, a displacement data between a pair of electrodes composed of a temporal change and the maximum displacement of the displacement between the pair of electrodes obtained in a state where there is no gap between welded materials and both electrodes are perpendicularly pressurizing the welded materials (e.g., JP2000-005882 A). This welding device is configured to compare the obtained displacement data between the pair of electrodes with the stored reference data to determine reliability of welding condition, of a nugget diameter and the like and quality abnormalities.

### SUMMARY OF THE INVENTION

### Technical Problem

A correlative relationship between the displacement between the pair of electrodes and the nugget diameter may change depending on the welding condition of the welded material. In this case, the conventional art may not be able to estimate the nugget diameter with high accuracy.

### Solution to Problem

It is possible to realize the present disclosure as the following aspects.

(1) In accordance with one aspect of the present disclosure, there is provided a nugget diameter estimation method of a welded material bonded by resistance spot welding. The nugget diameter estimation method includes: a reference welding process of a bonding test material corresponding to the welded material through energization while pressurizing the test material with a pair of electrodes, the reference welding process of bonding the test material while measuring an expansion amount of the test material; a nugget diameter measurement process of measuring a nugget diameter of the bonded test material; a relational formula determination process of determining a relational formula between the measured nugget diameter of the test material and the expansion amount of the test material; a main welding process of measuring an expansion amount of the welded material, and bonding the welded material through energization while pressurizing the welded material with the pair of electrodes; and a nugget diameter estimation process of estimating a nugget diameter of the bonded welded material using the expansion amount of the welded material and the relational formula.

In accordance with this aspect of the nugget diameter estimation method, it is possible to determine the relational formula having a strong correlation between the expansion amount and the nugget diameter by using the measured value of the expansion amount and the measured value of the nugget diameter in the reference welding process, thereby improving estimation accuracy of the nugget diameter of the welded material obtained in the main welding process.

(2) In the above-described aspect of the nugget diameter estimation method, the reference welding process may bond the test material using a reference welding condition for gradually increasing the expansion amount from a start time of the energization to an end time of the energization.

In accordance with this aspect of the nugget diameter estimation method, it is possible to suppress changes in the correlative relationship between the expansion amount and the nugget diameter during the welding. Accordingly, it is possible to improve the estimation accuracy of the nugget diameter.

(3) In the above-described aspect of the nugget diameter estimation method, the reference welding condition may be to increase a welding current value so as to be up to a predetermined first current value after starting the energization and then gradually increase the welding current value so as to be up to a predetermined second current value at a predetermined end time of the energization.

In accordance with this aspect of the nugget diameter estimation method, it is possible to more gradually increase the expansion amount of the melted portion of test material, compared with a reference welding condition to increase the welding current value up to the second current value immediately after the start of the energization and then is held at the second current value until the end of the energization. It is possible to suppress changes in the correlative relationship between the expansion amount and the nugget diameter during the welding, thereby improving the estimation accuracy of the nugget diameter.

(4) In the above-described aspect of the nugget diameter estimation method, the reference welding condition may be to increase a welding current value so as to be up to a predetermined first current value after starting the energization and then gradually increase the welding current value until one cycle of a power supply frequency before a predetermined end time of the energization.

In accordance with this aspect of the nugget diameter estimation method, it is possible to further expand a range of the condition for improving the estimation accuracy of the nugget diameter than a case where the expansion amount is increased until the end time of the energization.

(5) In the above-described aspect of the nugget diameter estimation method, the reference welding process may include a process of bonding a plurality of the test materials while measuring expansion amounts of the plurality of the test materials using a plurality of levels of welding current values. The nugget diameter measurement process may include a process of measuring nugget diameters of the plurality of the bonded test materials. The relational formula determination process may include a process of determining the relational formula using the nugget diameters of the plurality of the measured test materials and the expansion amounts of the plurality of the measured test materials.

In accordance with this aspect of the nugget diameter estimation method, it is possible to improve the estimation accuracy of the nugget diameter by increasing the number of samples.

(6) In the above-described aspect of the nugget diameter estimation method, the relational formula determination process may include a process of determining the relational formula by a regression analysis using the nugget diameters of the plurality of the measured test materials and the expansion amounts of the plurality of the measured test materials.

In accordance with this aspect of the nugget diameter estimation method, it is possible to estimate the nugget diameter by a simple method using a regression equation.

(7) In the above-described aspect of the nugget diameter estimation method, the main welding process may include a process of bonding the welded material using one welding current value included in the plurality of levels of welding current values used in the reference welding process.

In accordance with this aspect of the nugget diameter estimation method, it is possible to improve the estimation accuracy of the nugget diameter using the regression analysis by matching the condition of the reference welding process and the condition of the main welding process.

It is also possible to implement the present disclosure in various aspects other than the estimation method of the nugget diameter. For example, it is possible to implement the present disclosure in aspects, such as a resistance spot welding method, a nugget diameter estimation device, a resistance spot welding device, or a control method of such devices, a computer program for implementing the control method, a non-transitory recording medium in which the computer program is recorded, and the like.

### BRIEF DESCRIPTION OF THE DRAWINGS

FIG. 1 is an explanatory diagram illustrating a schematic configuration of a resistance spot welding device;

FIG. 2 is a block diagram illustrating an internal functional configuration of a control device;

FIG. 3 is a flow chart of a resistance spot welding method as a first embodiment of the present disclosure;

FIG. 4 is a flow chart illustrating details of a reference welding process;

FIG. 5 is a flow chart illustrating details of a main welding process;

FIG. 6 is a graphic chart illustrating an example of changes in an expansion amount of test materials in the reference welding process;

FIG. 7 is an explanatory diagram illustrating a pattern of a welding current value set as a reference welding condition and a main welding condition of the resistance spot welding device according to the present embodiment;

FIG. 8 is an explanatory diagram illustrating a method of deriving a nugget diameter calculation formula;

FIG. 9 is a graphic chart illustrating a change in an expansion amount of a welded material in the main welding process;

FIG. 10 is a graphic chart illustrating changes in an expansion amount of comparative samples; and

FIG. 11 is an explanatory diagram illustrating an evaluation result of estimation accuracy of nugget diameters of welded materials prepared using main welding conditions and comparative samples.

### DETAILED DESCRIPTION

### A. First Embodiment

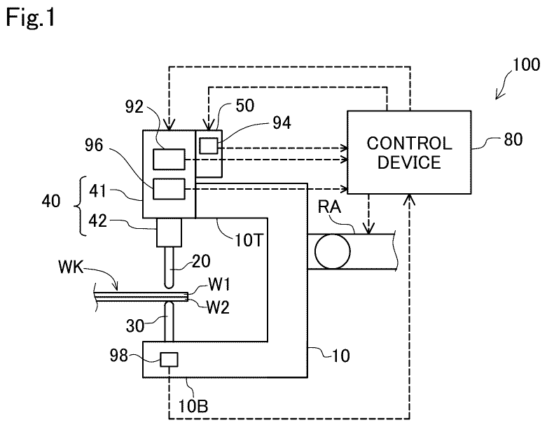

FIG. 1 is an explanatory diagram illustrating a schematic configuration of a resistance spot welding device 100. The resistance spot welding device 100 bonds a plurality of metal members to each other by resistance spot welding. Moreover, the resistance spot welding device 100 executes a nugget diameter estimation method of welded materials WK according to a first embodiment of the present disclosure. In the present embodiment, two plate materials W1 and W2 are bonded to each other, which are made of alloyed hot-dip galvannealed steel sheets (also referred to as “GA steel plate”) having a thickness of approximately 1 to 2 mm, as the plurality of metal members.

The resistance spot welding device 100 includes a welding gun 10, robot arm RA, and a control device 80. The welding gun 10 includes a movable electrode side arm 10T, a movable electrode 20 and a fixed electrode 30 constituting a pair of electrodes, a fixed electrode side arm 10B formed continuously with the movable electrode side arm 10T, an electrode raising/lowering device 40, and a current adjustment device 50.

The welding gun 10 is held by the robot arm RA. The movable electrode 20 is attached to the movable electrode side arm 10T of the welding gun 10 via the electrode raising/lowering device 40. The fixed electrode 30 is attached to the fixed electrode side arm 10B of the welding gun 10. The movable electrode 20 and the fixed electrode 30 are arranged so that their tips face each other. When welding the welded material WK, the welded material WK is clamped between the movable electrode 20 and the fixed electrode 30 to be energized while being pressurized. Consequently, the welded material WK is melted due to resistance heating and then solidifies, and thereby the plate materials W1 and W2 are bonded to each other. When the welded material WK is energized from the movable electrode 20 and the fixed electrode 30, the welded material WK is melted and thereby expands. In the present disclosure, the plate materials W1 and W2 in a state of being bonded to each other and the plate materials W1 and W2 superposed before bonding are also referred to as “welded material WK” for convenience of explanation.

The electrode raising/lowering device 40 is an electrically-operated device that raises and lowers the movable electrode 20. The electrode raising/lowering device 40 is attached to a tip of the movable electrode side arm 10T of the welding gun 10. The electrode raising/lowering device 40 includes a servo motor 41 and a raising/lowering member 42. The raising/lowering member 42 is linked to a driving shaft of the servo motor 41 via an unillustrated gear. The electrode raising/lowering device 40 raises and lowers the raising/lowering member 42 by operating the servo motor 41 in accordance with a command signal from the control device 80. The welded material WK is clamped between the movable electrode 20 and the fixed electrode 30 in a state where the raising/lowering member 42 is lowered.

The current adjustment device 50 adjusts a current value of a welding current to flow between the movable electrode 20 and the fixed electrode 30 in accordance with a current command signal transmitted from the control device 80. It is possible to apply, for example, a device including a variable resistor, a device including a converter, or the like, as the current adjustment device 50.

The resistance spot welding device 100 further includes measuring devices including a pressurizing force measurement unit 92, a current measurement unit 94, a movable electrode displacement measurement unit 96, and a fixed electrode displacement measurement unit 98. These measuring devices are electrically connected to the control device 80, and a measured result obtained by each measuring device is transmitted to the control device 80.

The pressurizing force measurement unit 92 measures a pressurizing force applied by the movable electrode 20 and the fixed electrode 30 to the welded material WK. The pressurizing force measurement unit 92 is, for example, a load cell housed inside the electrode raising/lowering device 40. The current measurement unit 94 is a current sensor and measures the welding current value flowing between the movable electrode 20 and the fixed electrode 30.

The movable electrode displacement measurement unit 96 measures a raised/lowered position of the movable electrode 20. The movable electrode displacement measurement unit 96 is an encoder housed inside the electrode raising/lowering device 40. The movable electrode displacement measurement unit 96 detects a rotation angle position of an output shaft of the servo motor 41 to measures the raised/lowered position of the movable electrode 20, thereby obtaining a position of the movable electrode 20. The movable electrode displacement measurement unit 96 obtains, by using an initial position of the movable electrode 20 at the start of energization in the reference welding or the main welding as a reference, the position of the movable electrode 20 with respect to the initial position as a displacement.

The fixed electrode displacement measurement unit 98 is a strain sensor. The fixed electrode displacement measurement unit 98 measures a strain amount of the fixed electrode side arm 10B. In the present embodiment, the fixed electrode displacement measurement unit 98 measures the strain amount of the fixed electrode side arm 10B at the time of pressurizing the welded material WK. The fixed electrode displacement measurement unit 98 multiplies the measured strain amount by a coefficient predetermined as characteristics of the welding gun 10, thereby obtaining a position of the fixed electrode 30. The fixed electrode displacement measurement unit 98 obtains, by using an initial position of the fixed electrode 30 at the start of energization in the reference welding or the main welding as a reference, the position of the fixed electrode 30 with respect to the initial position as a displacement.

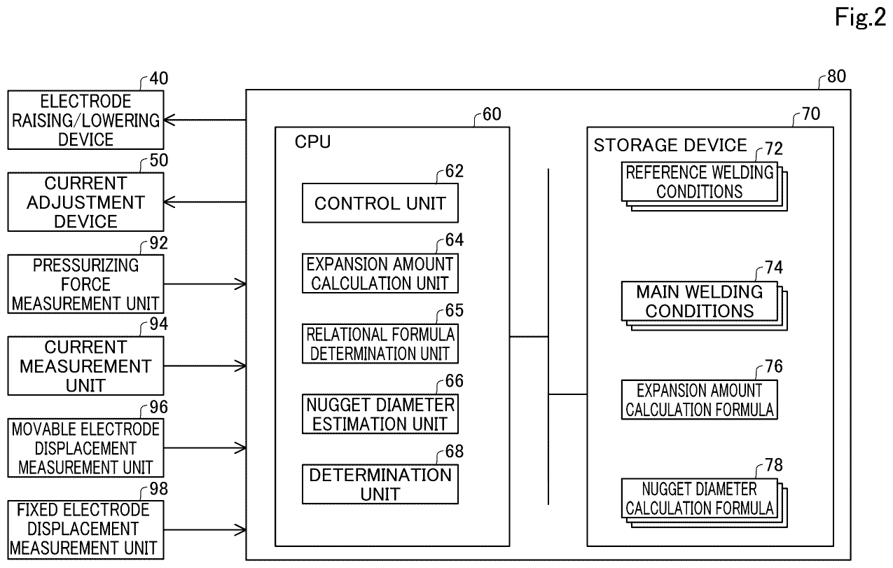

FIG. 2 is a block diagram illustrating an internal functional configuration of the control device 80. The control device 80 includes a CPU 60 as a central processing unit, a storage device 70, an unillustrated timer for measuring time, and an unillustrated input/output interface. These components are communicatively connected to one another through an internal bus.

The CPU 60 executed a control program(s) previously stored in the storage device 70, thereby functioning as a control unit 62, an expansion amount calculation unit 64, a relational formula determination unit 65, a nugget diameter estimation unit 66, and a determination unit 68. The control unit 62 comprehensively controls each operation of the resistance spot welding device 100, specifically, a current value, an energization time, a pressurizing force of an electrode, energization timing, pressurization timing, and the like.

The expansion amount calculation unit 64 calculates an expansion amount of the welded material WK using an expansion amount calculation formula 76 stored in the storage device 70. The relational formula determination unit 65 determines a nugget diameter calculation formula 78, which is a relational formula between a nugget diameter of the test material and an expansion amount of the test material, using an expansion amount and a nugget result in the reference welding. The nugget diameter estimation unit 66 calculates an estimated value of a nugget diameter of the welded material WK bonded by the main welding process, using the nugget diameter calculation formula 78 stored in the storage device 70. The determination unit 68 determines whether or not the welded material WK after the main welding is a non-defective product, using the estimated value of the nugget diameter calculated by the nugget diameter estimation unit 66.

The storage device 70 is, for example, a RAM, a ROM, or a hard disk drive (HDD). The HDD or ROM stores various programs for implementing a function provided by the present embodiment. The various programs read from HDD or ROM are developed on the RAM to be executed by the CPU 60. A readable/writable area in the storage device 70 includes a storage section for storing reference welding conditions 72, main welding conditions 74, the expansion amount calculation formula 76, and the nugget diameter calculation formula 78.

The reference welding conditions 72 are processing conditions of the test material used for the reference welding process. The main welding conditions 74 are processing conditions of the welded material WK used for the main welding process. The reference welding conditions 72 and the main welding conditions 74 are different respectively for types of or combinations of the test material and the welded material WK, and therefore the number of conditions corresponding thereto are stored. As described later, it is preferable that the reference welding conditions 72 further include a plurality of levels of conditions for one type of test material, when using a regression analysis in order to calculate a relational formula between a nugget diameter of the test material and an expansion amount of the test material used for the reference welding. In the present embodiment, the reference welding conditions 72 include three levels of welding current conditions, “high”, “medium”, and “low” for each type of the test material.

The expansion amount calculation formula 76 is used in order to calculate expansion amounts of the welded material WK and the test material. For example, it is possible to express the expansion amount calculation formula 76 by the following formula (1):

En=ΔD+ΔP (1)

where En is an expansion amount of the welded material WK or the test material. The expansion amount En corresponds to an expansion amount in a perpendicular direction to a plane direction of the welded material WK or the test material. ΔD is a displacement of the movable electrode 20 and corresponds to a displacement of the movable electrode 20 obtained by the movable electrode displacement measurement unit 96. ΔP is a displacement of the fixed electrode 30 and corresponds to a displacement of the fixed electrode 30 obtained by the fixed electrode displacement measurement unit 98.

The nugget diameter calculation formula 78 is used in order to estimate a nugget diameter of the welded material WK bonded by the main welding. In the present embodiment, the nugget diameter calculation formula 78 is obtained by, for example, a regression analysis such as a least squares method, using an actual measured value of the nugget diameter of the test material welded by the reference welding and an expansion amount of the test material during the reference welding, as described later. The nugget diameter calculation formula 78 is different for each type of or combination of the welded material WK, and therefore the number of formulas corresponding thereto these is stored.

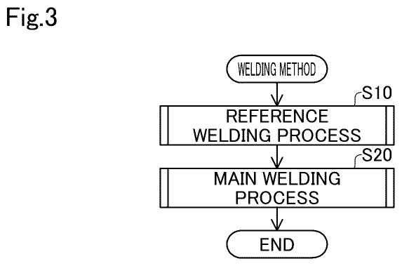

FIG. 3 is a flow chart of a resistance spot welding method as a first embodiment of the present disclosure. In Step S10, a reference welding process is executed by the resistance spot welding device 100. In the reference welding process, the nugget diameter calculation formula 78 is determined and then is stored in the storage device 70. In Step S20, a main bonding process is executed by the resistance spot welding device 100. In the main bonding process, the welded material WK is bonded by welding and an estimated value of the nugget diameter of the bonded welded material WK is calculated.

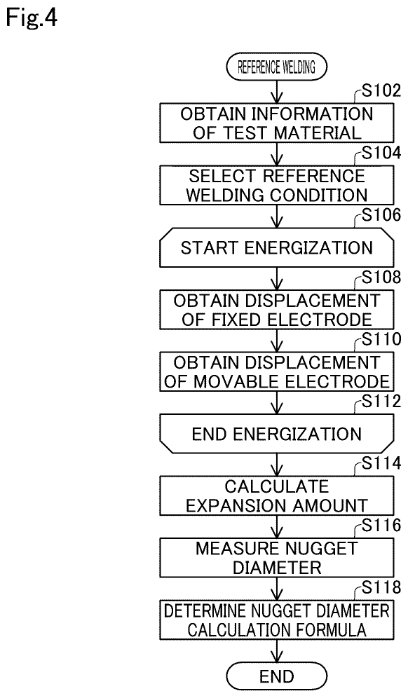

FIG. 4 is a flow chart illustrating details of the reference welding process. Information on the test material is obtained in Step S102. The test material may be the welded material WK or may be another material having similar factors affecting the welding, such as material and thickness, to the welded material WK. The control unit 62 obtains identification information, such as a type of the test material, by, for example, recognizing the test material using a captured image thereof etc., or by receiving or reading identification information labeled to test materials, such as an RF tag and a two-dimensional code. In Step S104, the control unit 62 selects the reference welding condition 72 corresponding to the obtained identification information.

In Step S106, the control unit 62 starts energization to the test material. Specifically, the control unit 62 transmits an electrode position command signal to the electrode raising/lowering device 40 to move the movable electrode 20 to an electrode position corresponding to the selected reference welding condition 72. The control unit 62 transmits a current command signal to the current adjustment device 50 to flow a welding current through the test material in accordance with the welding current value set in the reference welding condition 72. The reference welding condition 72 sets three levels of welding current conditions for each type of the test material, in the present embodiment. Then, Steps S106 to S112 are repeated for each level of the welding current. Moreover, the number of samples is increased in order to improve estimation accuracy of the nugget diameter calculation formula 78, in the present embodiment. Specifically, three samples are processed for each level. Namely, in the reference welding process, three samples are processed for each three levels of welding current, thereby preparing a total of nine samples. It is to be noted that welding may be performed on a different test material for each welding current condition, or welding may be performed at a different position on one test material for each welding current condition.

In Step S108, the expansion amount calculation unit 64 obtains a displacement ΔD of the movable electrode 20 from the movable electrode displacement measurement unit 96. In Step S110, the expansion amount calculation unit 64 obtains a displacement ΔP of the fixed electrode 30, which is a displacement of the fixed electrode 30, from the fixed electrode displacement measurement unit 98. It is to be noted that Steps S108 and S110 are repeatedly executed, for example, every 2 msec. during the reference welding so as to be able to confirm a time variation in the expansion amount.

In Step S112, the control unit 62 ends the energization to the test material in accordance with an end time of the energization set in the reference welding condition 72. The energization time may be set as a time or may be set as a number of cycles of the power supply frequency. In Step S114, the expansion amount calculation unit 64 calculates the expansion amount En of the welded material WK in accordance with the expansion amount calculation formula 76 using the displacement ΔD of the movable electrode 20 and the displacement ΔP of the fixed electrode 30 both obtained during the energization. It is to be noted that Step S114 may be executed in so-called real time during the energization executed from Steps S106 to S112.

Step S116 is a nugget diameter measurement process to measure a nugget diameter of the test material bonded by reference welding. In the present embodiment, welded portions of the test materials prepared respectively under the three levels of welding current conditions are cut to actually measure the nugget diameters. It is preferable to etch a cut surface with, for example, a saturated aqueous solution of picric acid or the like after polishing, in order to facilitate the measurement of the nugget diameter. The nugget diameter may be measured by various methods, and may be measured non-destructively using any measuring device.

Step S118 is a relational formula determination process. The relational formula determination unit 65 determines the nugget diameter calculation formula 78 using the expansion amount En calculated in Step S114 and the nugget diameter measured in Step S116. The nugget diameter calculation formula 78 is determined by a regression analysis using the expansion amount En of each of the three levels of welding current conditions and the actual measured value of the nugget diameter, in the present embodiment. The determined nugget diameter calculation formula 78 is stored in the storage device 70. It is to be noted that the relational formula determination unit 65 uses a peak value of the expansion amount of the test material up to the end time of the energization as the expansion amount En, as described later. The reference welding is ended as determining the nugget diameter calculation formula 78.

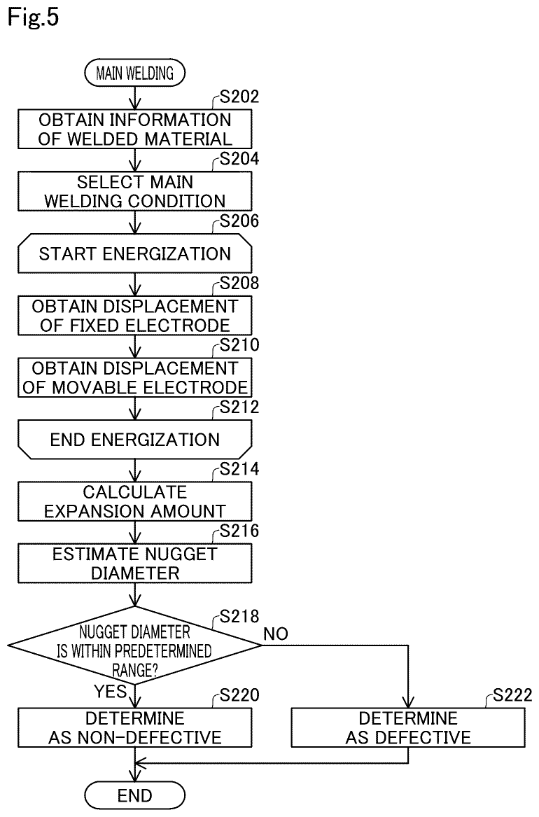

FIG. 5 is a flow chart illustrating details of the main welding. In Step S202, identification information of the welded material WK is obtained by the similar method to that of Step S102 described above. In Step S204, selected and obtained is the main welding condition 74 corresponding to the identification information of the welded material WK. It is preferable that the selected main welding condition 74 is matched to one condition included in the reference welding conditions 72. Consequently, it is possible to strengthen a correlation between the reference welding and the main welding, thereby improving the estimation accuracy using the nugget diameter calculation formula 78. In the present embodiment, the welding current of the main welding condition 74 is matched to the “medium” level of the welding current among the three levels of welding currents included in the reference welding conditions 72.

In Step S206, the control unit 62 starts energization to the welded material WK. Each process from Steps S206 to S214 is the same as that of Steps S106 to S114 of the reference welding process, except for one welded material WK being prepared using the main welding condition 74 having one level of welding current value, and therefore the description is omitted.

Step S216 is a nugget diameter estimation process. The nugget diameter estimation unit 66 estimates a nugget diameter of the welded material WK bonded in the main welding process. The nugget diameter estimation unit 66 calculates an estimated value of the nugget diameter using the expansion amount calculated in Step S214 on the basis of the nugget diameter calculation formula 78 determined in Step S118 of the reference welding.

In Step S218, the determination unit 68 determines whether or not the calculated estimated value of the nugget diameter is within a predetermined range stored in the storage device 70. If the nugget diameter is within the predetermined range (YES in S218), the process proceeds to Step S220, and the determination unit 68 determines that the welded material WK is a non-defective product and ends the process. If the nugget diameter is not within the predetermined range (NO in S218), the process proceeds to Step S222, and the determination unit 68 determines the welded material WK is defective and ends the process.

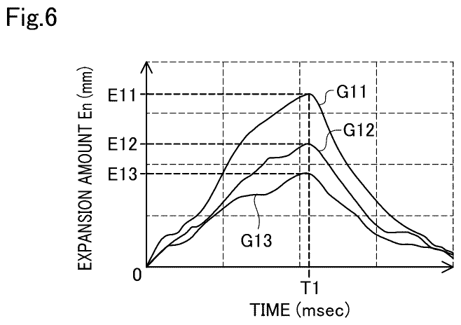

FIG. 6 is a graphic chart illustrating an example of changes in an expansion amount of test materials in the reference welding process. The horizontal axis of the graphic chart indicates an elapsed time (unit: msec.) starting from the start time of the energization. The vertical axis indicates the expansion amount En (unit: millimeter) of the test material calculated by the expansion amount calculation unit 64 using the expansion amount calculation formula 76. As described above, the reference welding conditions 72 are set with three levels of welding currents, i.e., “high”, “medium”, and “low”, as the welding conditions, in the present embodiment. The graph G11 indicates a calculated result of the expansion amount En under the condition of the “high” welding current, the graph G12 indicates a result under the condition of the “medium” welding current, and the graph G13 indicates a calculated result of the expansion amount under the condition of the “low” welding current. It is to be noted that actually, there are measured results of three samples of the expansion amount En for each level of welding current, but illustration is omitted for convenience of the description.

The time T1 illustrated in FIG. 6 indicates the end time of the energization. The relational formula determination unit 65 obtains a peak value of the expansion amount En up to the time T1 in each graph G11 to G13. In the present embodiment, each graph G11 to G13 indicates an upward tendency in the expansion amount En from the start of the energization to the time T1, as illustrated in FIG. 6. The peak values of the expansion amount En are expansion amounts E11 to E13 at the time T1. It is to be noted that when the expansion amount peaks out between the start of energization and the end of energization, the relational formula determination unit 65 uses a peak expansion amount regardless of the end time of the energization.

In the present embodiment, the direction of expansion of the welded material WK calculated as the expansion amount En is a perpendicular direction with respect to the plane direction of the welded material WK. In contrast, the nugget diameter estimated in the present embodiment is a diameter in a direction different from the direction of expansion of the expansion amount En, specifically, in a direction along the plane direction of the welded material WK. Here, for example, when the melted portion of the welded material WK largely expands by the resistance spot welding, the welded portion in a vicinity of the fixed electrode 30 and the movable electrode 20 may be cooled due to thermally dissipation to these electrodes. The inventors have newly found that, in this case, the melted portion is less likely to grow in the perpendicular direction of the welded material WK and is more likely to grow in the direction along the plane direction of the welded material WK. When the melted portion further grows along the plane direction, it is pushed out in a direction away from the welding position and becomes more likely to flow between the plate materials W1 and W2 of the welded material WK. In such a case, the expansion amount in the perpendicular direction of the melted portion decreases, and the expansion amount in the plane direction increases. Consequently, the correlative relationship between the expansion amount En to be obtained and the nugget diameter may change, and therefore it may not be possible to estimate the nugget diameter with sufficient accuracy even using the expansion amount En.

In the present embodiment, the welding conditions is selected such that the expansion amount En increases until the end time of the energization in order to stabilize the correlative relationship between the expansion amount En to be obtained and the nugget diameter. This is because it is considered that while the expansion amount increases in the perpendicular direction, the expansion amount in the planar direction of the melted portion is unlikely to increase. However, the expansion amount does not necessarily have to continue to increase until the end time of the energization. For example, in accordance with experimental results, it is possible to obtain the same degree of estimation accuracy of the nugget diameter if the expansion amount En increases until one cycle of the power supply frequency before the end time of energization.

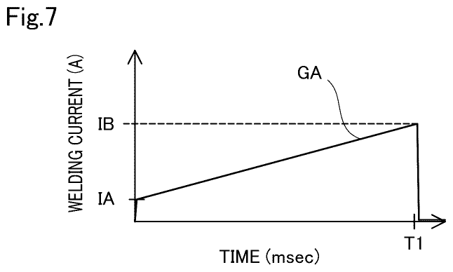

FIG. 7 is an explanatory diagram illustrating a pattern of a welding current value set as the reference welding conditions 72 and the main welding conditions 74 of the resistance spot welding device 100 according to the present embodiment. The horizontal axis of the graphic chart indicates an elapsed time (unit: msec.) starting from the start time of the energization. The vertical axis indicates a welding current value (unit: ampere). The graph GA illustrated in a solid line in FIG. 7 is a master pattern of the welding current value. In the reference welding and the main welding, the control unit 62 operates the current adjustment device 50 so that a current having the pattern illustrated as the graph GA flows between the fixed electrode 30 and the movable electrode 20.

As illustrated in the graph GA, the welding current is adjusted by, for example, so-called up-slope control. In the up-slope control, the welding current is increased up to a first current value IA of several thousand amperes immediately after the start of energization, and then is gradually increased up to a second current value IB at the ending time point of the energization. Consequently, it is possible to gradually increase the expansion amount of the melted portion of the welded material WK, compared with, for example, control to increase the welding current up to second current value IB immediately after the start of the energization and to hold the second current value IB until the end of the energization. In the present embodiment, it is set the energization time capable of gradually increasing the expansion amount up to an expansion amount at which a desired nugget diameter is obtained without the expansion amount peaking out, as the reference welding conditions 72 and the main welding conditions 74. It is preferable to that the first current value IA and the second current value IB are not close to each other.

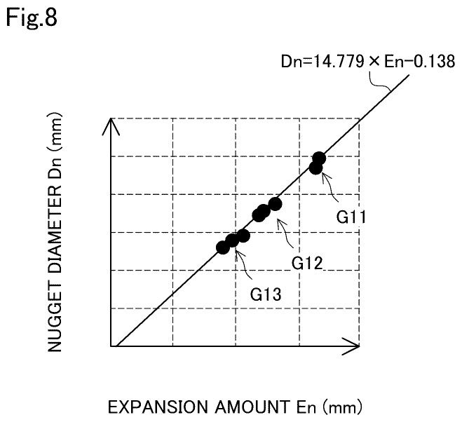

FIG. 8 is an explanatory diagram illustrating a method of deriving the nugget diameter calculation formula 78. FIG. 8 illustrates a correspondence relationship between an actual measured value of the nugget diameter obtained after the reference welding process and the peak value of each expansion amount En corresponding to the graphs G11 to G13 illustrated with FIG. 6. The vertical axis of the graph is the nugget diameter Dn (unit: millimeter), and the horizontal axis thereof is the expansion amount En (unit: millimeter). FIG. 8 plots the results of a total of nine samples, three samples for each of three levels of melting current value as the reference welding conditions 72.

The relational formula determination unit 65 determines a nugget diameter calculation formula 78 by a regression analysis using the nine plots illustrated in FIG. 8. In the present embodiment, the relational formula determination unit 65 determines the following formula (2) as the nugget diameter calculation formula 78:

Dn=14.779·En−0.138 (2)

where Dn is a measured result of the nugget diameter after the reference welding, and En is a peak value of the expansion amount En. The nugget diameter calculation formula 78 is different for each type of or combination of the test material and the welded material WK. Here, the estimation accuracy of the nugget diameter may be different for each type of or combination of the test material and the welded material WK. In this case, a parameter different for each type of or combination of the test material and the welded material WK may be used for the nugget diameter calculation formula 78 in order to improve the estimation accuracy. For example, the expansion amount En may be an integral value of the expansion amount instead of the peak value of the expansion amount. The integral value of the expansion amount may be an integral value from the start time of the energization to the end time of the energization. The integral value of the expansion amount may be an integral value from the start time of the energization to a time, which is freely set, later than the end time of the energization. The integral value of the expansion amount may be an integral value from the start time of the energization to one cycle of the power supply frequency before the end time of the energization. Alternatively, both the peak value of the expansion amount and the integral value of the expansion amount may be obtained to adopt the one having higher estimation accuracy of the nugget diameter.

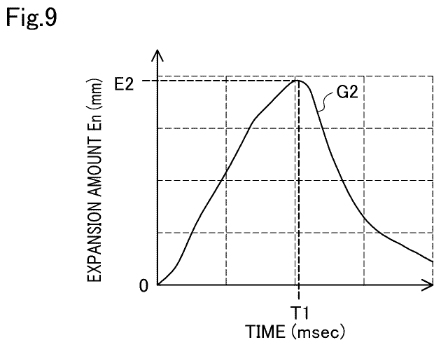

FIG. 9 is a graphic chart illustrating a change in an expansion amount of the welded material WK in the main welding process. The graph illustrated in FIG. 9 illustrates a result obtained from an experiment executed using the same welded material WK and the same main welding conditions 74 as the main welding process. The horizontal axis of the graphic chart indicates an elapsed time (unit: msec.) starting from the start time of the energization. The vertical axis indicates the expansion amount En (unit: millimeter) of the welded material WK calculated by the expansion amount calculation unit 64 using the expansion amount calculation formula 76. In the present embodiment, the welding current value of the main welding condition 74 is the “medium” welding current value among the three levels of welding currents included in the reference welding conditions 72. The welding current value of the main welding conditions 74 is set to include the welding current value of the main welding conditions 74 in the reference welding conditions 72 in order to improve accuracy of deriving the nugget diameter calculation formula 78 by means of the regression analysis.

In an experiment, ten types of samples are used to obtain changes in the expansion amount. For convenience of description, only the graph G2 illustrating one of the results among them is illustrated, and the rest results are omitted. The ten types of prepared samples are prepared under the same conditions to be fixed as the main welding conditions 74 as preparing conditions, such as pressurizing force and energization time, and under conditions including a predetermined noise for the so-called robust design in consideration of the noise. Specifically, the sample includes two samples prepared under noise-free conditions, and two samples each prepared under conditions with the four types of noise listed below, for a total of eight samples:
(1) a sample prepared in a state of a 1-millimeter board gap provided between the plate materials W1 and W2 of the welded material WK;
(2) a sample prepared with the electrode angled at an angle of only 3 degrees from the so-called a state of perpendicular to the surface where the electrode is positioned perpendicular to the welded material WK;
(3) a sample prepared with 3-mm deviation from the initial positional, of the welded material WK, also known as so-called teaching positional deviation; and
(4) a sample prepared using electrodes in a state of a certain degree of wear.

As illustrated in the graph G2, the expansion amount En have an increasing tendency up to the time T1 for ending the energization. Namely, the expansion amount E2 as peak value is obtained at the same time T1 as the reference welding, also in the main welding process, without the expansion amount En peaking out. The time T1 is the same as the end time of the energization in the reference welding conditions 72.

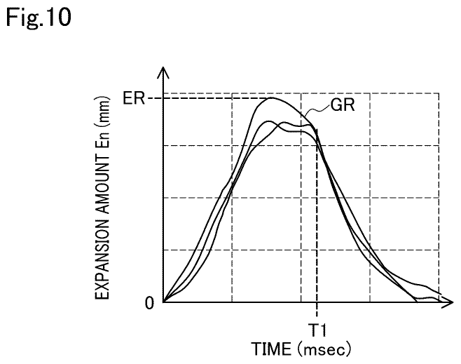

FIG. 10 is a graphic chart illustrating changes in an expansion amount of comparative samples. The N number of comparative samples is three, and three graphs are illustrated in FIG. 10. The preparation conditions of the comparative sample are the same as that of the welded material WK except that the master pattern for the welding current value is different therefrom. The master pattern of the welding current value used for preparing the comparative sample is different from the pattern illustrated in FIG. 7 in that current value is not gradually increased until the end of current flow, but is increased once to a predetermined current value immediately after the start of energization and then is held at the current value until the end of the energization. As illustrated in FIG. 10, in the comparative sample, the expansion amount En reaches a peak expansion amount ER before the end of the energization, and then the time T1 elapses after the peaking out. In this case, the relational formula determination unit 65 determines the nugget diameter calculation formula 78 using the expansion amount ER.

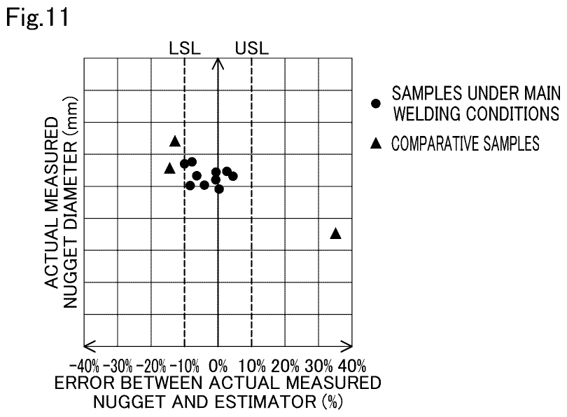

FIG. 11 is an explanatory diagram illustrating an evaluation result of estimation accuracy of nugget diameters of welded materials WK prepared using main welding conditions 74 and comparative samples. The evaluation results shown in FIG. 11 are obtained by cutting the prepared welded material WK and the comparative sample and measuring the actual nugget diameters thereof. The horizontal axis of the graph in FIG. 11 indicates an error against the actual measured value of the estimated value of nugget diameter calculated using the nugget diameter calculation formula 78, with respect to the actual measured value of the nugget diameter. Specifically, it is a result of subtracting the actual measurement value from the estimated value and then dividing it by the actual measurement value. The closer the value is to zero, the more accurate the estimation. The circular plots illustrated in FIG. 11 are evaluation results of the welded material WK prepared using the main welding conditions 74, and the triangular plots are evaluation results of the comparative samples illustrated with FIG. 10. The welded materials WK prepared using the main welding conditions 74 are samples prepared under 10 types of conditions including the noise illustrated in FIG. 9.

As illustrated in FIG. 11, the welded material WK prepared using the main welding conditions 74 has an error between the actual measured value and the estimated value of the nugget diameter within 10%, regardless of the presence or absence of noise, which is a more favorable result than an error in the comparative sample. This is considered to be because the expansion amount En does not peak out within the energization time by using the up-slope control for the master pattern of the welding current, thereby improving the estimation accuracy of the expansion amount En.

As described above, the nugget diameter estimation method of the welded material WK according to the present embodiment includes: a reference welding process of bonding a test material while measuring an expansion amount En of the test material; a nugget diameter measurement process of measuring a nugget diameter Dn of the bonded test material; a relational formula determination process of determining a relational formula between the measured nugget diameter Dn of the test material and the expansion amount En of the test material; a main welding process of bonding the welded material WK while measuring an expansion amount En of the welded material WK; and a nugget diameter estimation process of estimating a nugget diameter Dn of the bonded welded material WK using the expansion amount En of the welded material WK and the determined relational formula. In the reference welding process, it is possible to determine a relational formula having a strong correlation between the expansion amount En and the nugget diameter Dn by using the actual measured value of the expansion amount En and the actual measured value of the nugget diameter Dn, thereby improving the estimation accuracy of the nugget diameter of the welded material WK obtained in the main welding process.

In accordance with the nugget diameter estimation method of the welded material WK in the present embodiment, the setting conditions are used such that the expansion amount En gradually increases until the end time of the energization, without the expansion amount En peaking out during the welding, at the time of the determination of the nugget diameter calculation formula 78. Accordingly, it is possible to suppress or prevent a defect in which the correlative relationship between the expansion amount En and the nugget diameter Dn changes and the estimation accuracy of the nugget diameter decreases, thereby further improving the estimation accuracy of the nugget diameter.

### B. Other Embodiments

(B1) The above-described embodiment has illustrated examples of storing the reference welding conditions 72, the main welding conditions 74, the expansion amount calculation formula 76, and the nugget diameter calculation formula 78 in the storage device 70 provided in the control device 80. In contrast, the reference welding conditions 72, the main welding conditions 74, the expansion amount calculation formula 76, and the nugget diameter calculation formula 78 may be stored in, for example, a server capable of communicating with the control device 80. In this case, the control device 80 is capable of connecting to the server through a wide area network (WAN) such as the Internet or a local area network (LAN) to obtain and store various conditions.

(B2) The above-described embodiment has illustrated examples of setting the three levels of welding current conditions, “high”, “medium”, and “low”, for each type of the test material, as the reference welding conditions 72. In contrast, the reference welding conditions 72 may be set as two levels of conditions with different magnitudes of the welding current, or may be set as any level of welding current such as three or more levels. In addition, although the examples have been illustrated in which the welding current value of the main welding conditions 74 is included in the three levels of welding current value of the reference welding conditions 72, the welding current value of the main welding conditions 74 and the welding current value of the reference welding conditions 72 may be different from each other.

(B3) The above-described embodiment has illustrated examples of manufacturing the welded material WK by welding the plate materials W1 and W2, which are two GA plates, to each other. In contrast, the number of plate materials may be three or more, and the plate materials may be made of various metal materials such as, aluminum alloy, magnesium, titanium, copper, and the like other than iron (steel). Alternatively, it may be welding between dissimilar metals.

The present disclosure is not limited to the above-described embodiments, and is implementable with various configurations without departing from the spirit of the present disclosure. For example, it is possible to replace or combine, as appropriate, the technical features of the embodiments corresponding to the technical features in the embodiments described in SUMMARY in order to solve some or all of the above-described problems or to achieve some or all of the above-described effects. Moreover, when the technical features are not described herein as essential, it is possible to delete, as appropriate, such technical features.

1. A nugget diameter estimation method of a welded material bonded by resistance spot welding, the nugget diameter estimation method comprising:
a reference welding process of bonding a test material corresponding to the welded material through energization while pressurizing the test material with a pair of electrodes, the reference welding process of bonding the test material while measuring an expansion amount of the test material;
a nugget diameter measurement process of measuring a nugget diameter of the bonded test material;
a relational formula determination process of determining a relational formula between the measured nugget diameter of the test material and the measured expansion amount of the test material;
a main welding process of measuring an expansion amount of the welded material, and bonding the welded material through energization while pressurizing the welded material with the pair of electrodes; and
a nugget diameter estimation process of estimating a nugget diameter of the bonded welded material using the expansion amount of the welded material and the determined relational formula.

2. The nugget diameter estimation method according to claim 1, wherein the reference welding process bonds the test materials using a reference welding condition for increasing the expansion amount from a start time of the energization to an end time of the energization.

3. The nugget diameter estimation method according to claim 2, wherein the reference welding condition is to increase a welding current value so as to be up to a predetermined first current value after starting the energization and then gradually increase the welding current value so as to be up to a predetermined second current value at a predetermined end time of the energization.

4. The nugget diameter estimation method according to claim 2, wherein the reference welding condition is to increase a welding current value so as to be up to a predetermined first current value after starting the energization and then gradually increase the welding current value until one cycle of a power supply frequency before a predetermined end time of the energization.

5. The nugget diameter estimation method according to claim 1, wherein:
the reference welding process includes a process of bonding a plurality of the test materials while measuring expansion amounts of the plurality of the test materials using a plurality of levels of welding current values;
the nugget diameter measurement process includes a process of measuring nugget diameters of the plurality of the bonded test materials; and
the relational formula determination process includes a process of determining the relational formula using the nugget diameters of the plurality of the measured test materials and the expansion amounts of the plurality of the measured test materials.

6. The nugget diameter estimation method according to claim 5, wherein
the relational formula determination process includes a process of determining the relational formula by a regression analysis using the nugget diameters of the plurality of the measured test materials and the expansion amounts of the plurality of the measured test materials.

7. The nugget diameter estimation method according to claim 6, wherein
the main welding process includes a process of bonding the welded material using one welding current value included in the plurality of levels of welding current values used in the reference welding process.
